(19) United States
(12) Patent Application Publication
(10) Pub. No.: US 2003/0099919 A1
(43) Pub. Date: May 29, 2003

(54) Bilingual toy

(76) Inventor: Tru Love, Palo Alto, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/322,241

(22) Filed: Dec. 17, 2002

Related U.S. Application Data
(63) Continuation-in-part of application No. 09/737,979, filed on Dec. 14, 2000.

(51) Int. Cl. G09B 19/06; G09B 19/08

(52) U.S. Cl. 434/157

(57) ABSTRACT

The present invention relates generally to the field of toy action figures, principally toy dolls constructed for teaching a second language other than a user's primary language.

### CROSS-REFERENCE TO RELATED APPLICATIONS

This application is a continuation-in-part of U.S. application Ser. No. 09/737,979, filed on Dec. 14, 2000, which is incorporated herein by reference in its entirety.

### BACKGROUND

1. Field of the Invention

The present invention relates generally to the field of toy action figures, principally toy dolls constructed for teaching a second language other than a user's primary language.

2. Description of the Related Art

Since their inception, toy dolls or action figures have been extremely popular with children in a broad range of ages. As this popularity has grown, prior art toy dolls and action figures have become more sophisticated, incorporating circuitry in the doll itself, or in attachments for the doll, which provides audible messages or sound effects.

U.S. Pat. No. 5,816,821 is directed to Bilingual Educational Dolls. The dolls disclosed therein have a pre-recorded song with bilingual educational lyrics. The child plays and pauses the songs for pre-determined times. Then the child records their own voice in repeating the lyrics of the pre-recorded songs in a foreign language. The doll is not provided with sensors or switches to activate the sound playback device.

U.S. Pat. No. 5,746,602 discloses a PC peripheral interactive doll. This is an interactive system for teaching, entertaining, and habituating a child utilizing an interactive entity such as a doll with a bidirectional communication link to a personal computer (PC). Scripted data stored at the computer directs doll activity and verbal articulation, and utilizes response from the child through the doll to the PC in directing output to the doll. Unfortunately, many in society cannot afford a PC and thus are denied the ability to further enhance their linguistic abilities.

U.S. Pat. No. 5,738,561 discloses a doll having a microphone and sound recording device along with a sound playback device and a speaker. The doll is provided with contacts or buttons to activate the sound recording device and the sound playback device. A child may speak to the doll and record messages, which may be played back at a later time. However, because the child records their own phrases for later playback this doll fails to relate a foreign word or phrase with its English equivalent.

### SUMMARY

The invention comprises a toy with at least one sensor or switch located thereon. Each individual sensor or switch, when activated energizes a battery. The battery activates an audio playback means located within the toy, which has words or phrases pre-recorded thereon. The word or phrase is repeated in two different foreign languages, preferably in a foreign language and in English. In another aspect, the word or phrase is repeated more than once in a foreign language and more than once in English. In yet another aspect, the word or phrase is repeated twice in a foreign language and twice in English.

In one aspect, the same words or phrases are repeated each time any one sensor or switch is activated. In this aspect, each sensor or switch is associated with only one word or phrase.

In another aspect, pre-recorded words or phrases are randomly accessed when any one sensor or switch is activated. For example, if a sensor is orange and it is located on a shoe, one phrase may be associated with the color orange and a second phrase may be associated with the shoe. A third phrase may be associated with the shoe and the color orange. Thus, when said sensor is activated, one word or phrase would be randomly selected for play.

In another aspect, the invention is a bilingual toy comprising: (a) at least one sensor or switch located on said toy, (b) an audio playback means located within said toy with one or more words or phrases contained thereon in two different languages, wherein said audio playback means is activated by said sensor or switch (c) said word or phrase is related to a feature upon which said sensor or switch is located and (d) a power source contained within said toy.

### BRIEF DESCRIPTION OF THE FIGURES

FIG. 1a is a front view of a representative toy doll (100) with sensors or switches located thereon.

FIG. 1b is a right view of the representative toy doll (100) shown with the audio playback means and speaker mechanism.

FIG. 1c is a rear elevation of the representative toy doll (100) shown with the rear of the costume in the open position to allow insertion of batteries.

FIG. 2 is a front view of a representative toy doll (200) shown with sensors or switches located on accessories and located on articles of clothing.

FIG. 3 is a front view of a representative toy doll (300) shown with sensors or switches located on accessories and located on articles of clothing which create a learning theme.

FIG. 4a is a front view of a representative toy electronic mat or pad (400) shown with sensors or switches located on shapes and shown with the audio playback means, battery and speaker, collectively the control unit.

FIG. 4b is a front view of a representative toy electronic mat or pad (400) shown with sensors or switches located on different colors.

FIG. 4c is a front view of a representative toy electronic mat or pad (400) shown with sensors or switches located on objects which create a learning theme.

FIG. 5 is a front view of a representative pull string toy (500) shown with sensors or switches.

FIG. 6 is a front view of the materials which could be included in a kit.

### DETAILED DESCRIPTION

I. Definitions

As used herein, the following terms or abbreviations, whether used in the singular or plural, will have the meanings indicated:

The term “toy” means any type of figure, doll, mat, pad, etc. which can be played with by an end user.

The terms “sensor” and “switch” are used interchangeably herein and refer to a sensing device. The sensor or switch may be open or closed. Also, the sensor or switch may be activated by hand pressure, sound or speech recognition to play back words or phrases pre-recorded on the audio playback means.

The term “foreign language” means a language other than English. Specific languages include, but are not limited to, Chinese, Portuguese, Japanese, German, Latin, Hebrew, French, Spanish, Russian, Italian, Swedish, Danish, Finnish, Norwegian, Dutch, Korean, Vietnamese, Hindi, Thai, Arabic, Czech, and Polish.

The term “anatomical feature” means any body part of the subject toy. Example body parts include, but are not limited to, those represented in Chart 1 below.

The term “audio playback means” refers to an electronic system or speech playback mechanism that has the capability to audibly communicate words or phrases to an end user. Examples of audio playback means, well known in the art, include a record player, cassette player, MP3 player and DVD/CD player. The audio playback means may be programmed via electronic medium, such as a record, cassette, ROM chip or CD.

The term “audio generating circuit” means an audio playback means and the requisite connecting circuitry.

The term “control unit” means the audio playback means, battery and speaker(s).

The term “random access” means that the word or phrase emitted from the audio playback means is randomly selected from one or more words or phrases recorded in association with any one sensor or switch. For example, three words could be pre-recorded for playing. Each time a sensor or switch is activated, only one of the three words would be randomly selected for play.

The term “article of clothing” means any type of clothing or wearable object that can be placed or dressed on the toy. Examples of articles of clothing include pants, dress, overalls, socks, shoes, boots, umbrella, shirt, tank top, sweater, t-shirt, sweatshirt, jacket, coat, pullover, cape, hat etc.

The term “accessory” means any type of small toy or object that could be connected to the toy via the electronic circuitry housed in the toy. Examples of accessories include, but are not limited to, musical instruments, tools, cooking utensils, paintbrush, small toys (ie. airplane), chair etc.

The term “written materials” may take the form of a small booklet, flashcards, posters and the like, to provide visual reinforcement. All printing materials are bilingual, written first in the corresponding foreign language then immediately followed in the English language.

The term “visual media” means any visual cue that may be used in conjunction with the toy. Examples include, but are not limited to, videotapes, DVDs, etc.

The term “audio media” means media that can be used in an appropriate piece of equipment to generate the audible sound. Examples include, but are not limited to, audio tapes, CD's, mini-disks, etc.

The term “learning theme” means that the toy would be decorated in articles of clothing and/or objects, optionally sold with accessories, which would help an end user learn foreign language terms about one particular sport, activity, place or thing. Examples of learning themes include, but are not limited to, a beach theme, a picnic, playing basketball, cooking a pie etc.

The terms “mat”, “pad” and “roll” can be used interchangeably.

| | Reference |
|---|---|
| Body Part | Number |
| Head | 101 |
| Head Frame | 102 |
| Hair | 103 |
| Eye | 104 |
| Nose | 105 |
| Mouth | 106 |
| Chin | 107 |
| Ear | 108 |
| Cheek | 109 |
| Forehead | 110 |
| Eyebrow | 111 |
| Neck | 112 |
| Arm | 113 |
| Shoulder | 114 |
| Elbow | 115 |
| Wrist | 116 |
| Hand | 117 |
| Finger | 118 |
| Leg | 119 |
| Thigh | 120 |
| Knee | 121 |
| Ankle | 122 |
| Foot | 123 |
| Toe | 124 |
| Torso or body | 125 |
| Naval | 126 |

II. Example Embodiments of the Toy

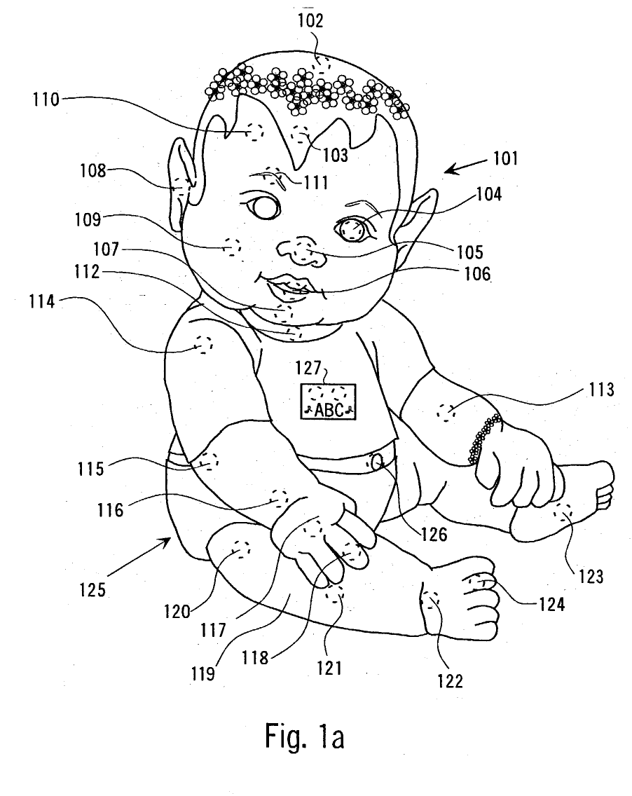

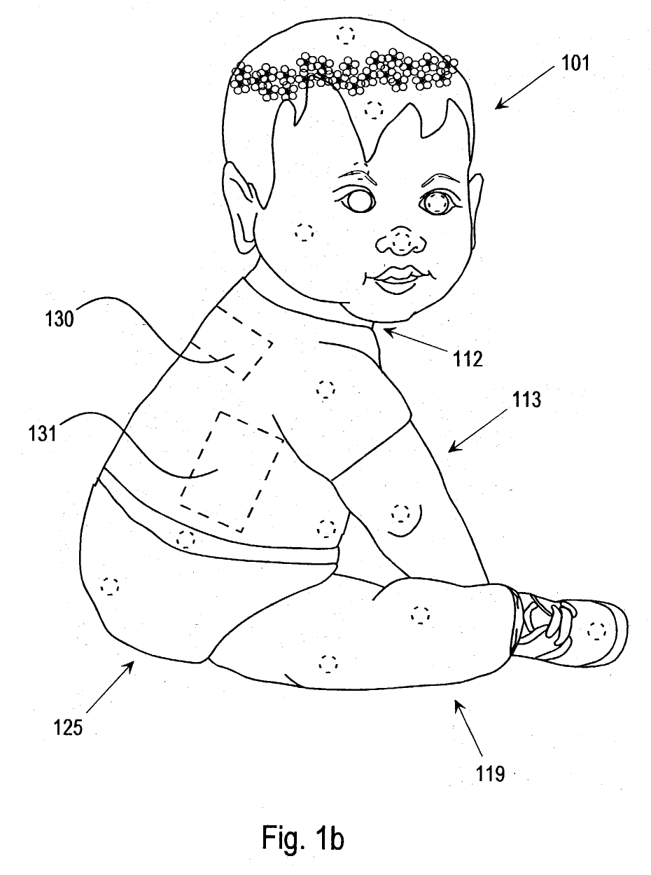

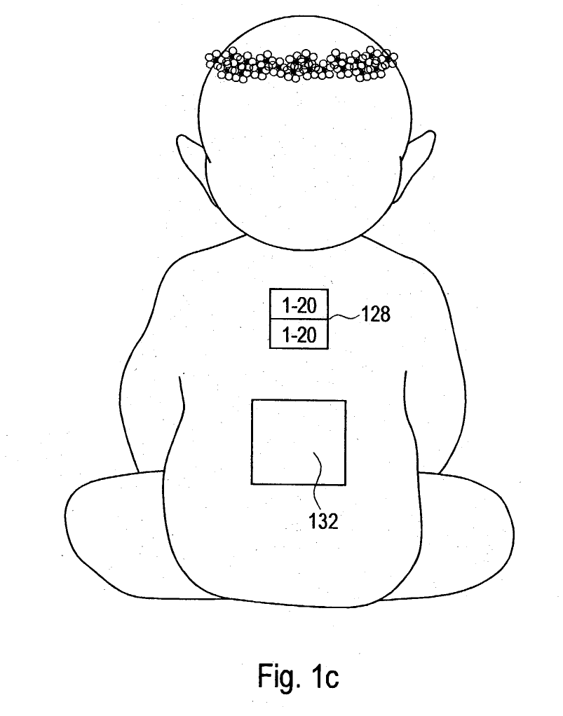

In one embodiment, illustrated in FIG. 1a, the toy is a doll (100) having a body or torso (125), in the middle of which is the belly (126) and to which arms (113) and legs (119) and a head (101)are connected. The head (101) is connected to the body by way of a neck (112). At the ends of the arms (113) are hands (117) with fingers (118), and at the ends of the legs (119) are feet (123) with toes (124). On the head (101) region, the doll has hair (103), eyes (104), ears (108), cheeks (109), a nose (105), a chin (107), eyebrows (111) and a mouth (106).

The torso (125) is uniform throughout the series with a hollow interior, (i.e., the body is filled with a polyfiber filling with sufficient room remaining for the electronic circuitry). The hollow interior has disposed and securely maintained therein the requisite electronic circuitry forming the audio generating system employed in the bilingual doll. Except for battery replacement, the hollow interior is securely covered, as the user does not need to access the circuitry. Battery replacement is easily performed by opening the battery access cover (132) on the backside of the toy (100), shown in FIG. 1c.

The internal mechanisms of the doll may be covered by any of the conventional materials used for stuffing and covering dolls. The outer surfaces or “skin” of the toy body should be made from a suitable soft or rubbery material and the body should be stuffed with a non-flammable, polymeric fiber-fill material, such as a spun or cut polycarbonate.

The doll comprises one or more sensors or switches located on one or more body parts near the doll's outer surface at various places, called contact points. The sensors or switches are depicted as broken-line circles in the figures. Each of the sensors/switches may be any type of electro-mechanical sensors/switches known in the art, but is preferably of the push-button momentary-type sensor/switch.

As shown in FIG. 1b, the audio playback means (131) can be mounted in any suitable region of the doll (100), preferably in the torso (125). The front forming portion of the torso may incorporate a plurality of apertures (or openings) formed therein, behind which is mounted a speaker (130) through which selected words and phrases enunciated by the doll (100) are transmitted for being easily heard by the user. Each sensor or switch activates the audio playback means (131) to play a different one of the pre-recorded words or phrases through the speaker mechanism (130). The speaker mechanism (130) can be mounted in any suitable region of the doll (100). Preferably, the speaker (130) is mounted in the torso region (125).

Not shown in the figures is the electronic circuitry which connects the sensors or switches to the audio playback means and the audio playback means to the speaker. Accordingly, any type of electronic circuitry well known in the art and capable of communicating data signals may be used.

The doll is structured so that activation of a sensor or switch on one area of the doll will immediately turn the power on the audio playback means (131) and play the word or phrase associated with the particular sensor or switch. In another aspect, activating one sensor or switch by pressing onto the area around the sensor or switch will not activate any other nearby sensor or switch in that region.

In another aspect the speech phrase will play even if another speech phrase is currently playing, i.e., it will supersede the earlier speech phrase.

In another aspect, shown in FIG. 1a, on the front of the torso (125) there are two switches located within a demarcated region referred to herein as the alphabet box (127). The alphabet box (127) is preferably on the chest of the doll as shown in FIG. 1a, but may be located anywhere on the doll (100) that is convenient. Activation of one of the switches or sensors within the alphabet box (127) will initiate the recitation of the alphabet in the foreign language, if applicable, while activation of the other switch or sensor will initiate the recitation in English.

In another aspect, shown in FIG. 1c, on the back of the doll there are two number boxes (128) with a switch or sensor located within each box. The number boxes (128) are preferably situated in the center of the back of the doll, however, they may be situated anywhere that is convenient. Activation of a switch or sensor within one of the number boxes (128) will initiate the recitation of the sequence of numbers in the foreign language while activation of the other switch or sensor will initiate the recitation in English. The sequence that is recited is indicated on the number box (128). The sequence of numbers recited may be any sequence but is preferably 1-10, more preferably 1-15 and most preferably 1-20. For example, in FIG. 1c, the sequence repeated upon activation of the upper box would be 1-20 in English. Likewise, if the lower box were activated, the sequence 1-20 would be repeated in a foreign language.

In another aspect, the pre-recorded word or phrase is related to the anatomical feature (ie. body part) where the sensor or switch is located on the doll.

For example, in FIG. 1a a sensor or switch located within the eyes (104) would repeat words or phrases appropriate to the eyes. Also, sensors or switches that activate the audio playback means to repeat words or phrases appropriate to the ear are situated directly on the ears (108) of the doll (100). The sensors or switches that activate the audio playback means to repeat words or phrases appropriate for the eyebrows are situated directly on the eyebrows (111). Similarly, sensors or switches that activate the audio playback means to repeat words or phrases appropriate to the forehead, nose and mouth, respectively, are situated within sections of the head frame (102) directly on the forehead (110), nose (105) and mouth (106), respectively. Likewise, sensors/switches that activate the audio playback means to repeat words or phrases appropriate to the hands are set within the material that comprises the hands (117) of the doll (100). Sensors or switches that activate the audio playback means to repeat words or phrases appropriate to the feet are set within the material that comprises the feet (123) of the doll (100). Speech-activating switches or sensors that activate the audio playback means to repeat words or phrases appropriate to the belly are situated within the stuffing material that comprises the naval region (126) of the toy (100).

Thus, if the sensor is located on the leg (119), the pre-recorded English word could be “leg” or optionally any part of the body associated with the leg, ie. “knee”, and the word would be repeated in a foreign language and in English. Likewise, a pre-recorded phrase could contain the English word “leg” or optionally any part of the body associated with the leg. An example of a phrase in English could be, “I can craw on my knees.” The pre-recorded phrase or sentence would be repeated in a foreign language and in English.

Where the anatomical feature exists bilaterally, i.e., on the left and right side of the doll, the speech activating sensors/switches may exist on one or both features/appendages. In other words, the sensors or switches which activate the audio playback means (131) and produce the pre-recorded words or phrases may be situated on either the left or right appendage, or there may be two sensors or switches (one on each appendage) that activate the audio playback means (131). Thus, for example, the left hand, the right hand or both the left and right hands may possess a sensor or switch. Each sensor or switch located on bilateral anatomical features may be programmed to repeat separate or different words or phrases.

In another embodiment, the doll further comprises wings with an upper and a lower portion.

In another embodiment, the pre-recorded word or phrase is related to the color of the sensor or switch. Any color commonly recognized could be used as a color of the sensors/switches. The sensor or switch may be made of a colored material, a colored material may be placed over the sensor to make it look a certain color or the sensor or switch may be located on (ie. positioned over) a colored material. Thus, if a sensor is orange, the pre-recorded English word could be “orange”, optionally any shade of orange commonly recognized, repeated in a foreign language and in English. Alternatively, the sensor may be located on or positioned over orange material. Accordingly, a pre-recorded phrase could contain the word “orange”, optionally any shade of orange commonly recognized, repeated in a foreign language and in English. An example of a phrase in English would be, “The color of my shoe is orange.”

In another embodiment, the pre-recorded word or phase is related to an article of clothing or accessory the sensor or switch is located on (ie. positioned over). Optionally, the pre-recorded word or phase is related to the color of the article of clothing or accessory that the sensor or switch is located on. Examples of articles of clothing include shoes, shirt, pants, hat, socks, etc. Examples of accessories include a small book, guitar, small toy, hockey stick, fork, soccer ball, basket ball, umbrella, etc. Thus, an accessory includes any object that can be connected via electronic circuitry to said toy.

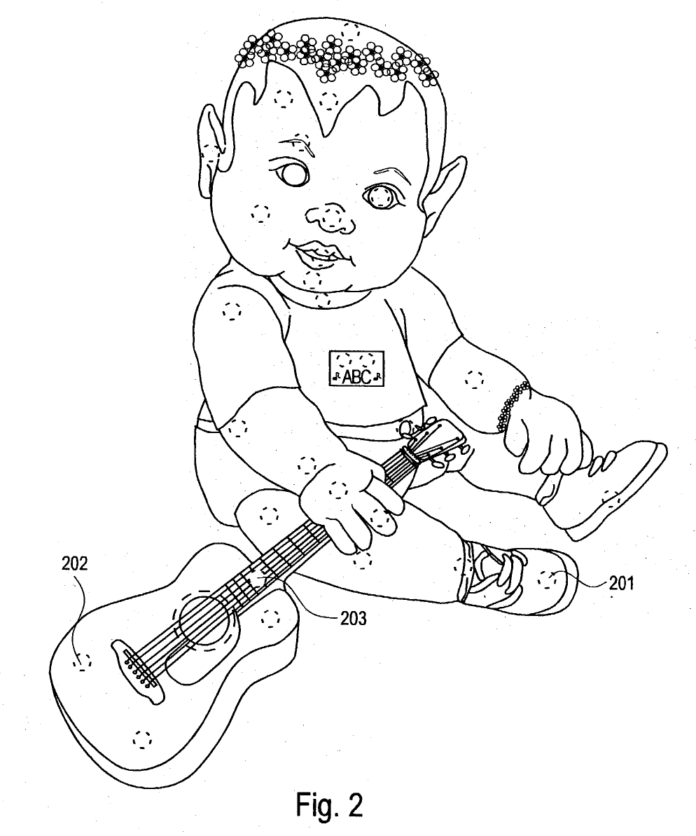

For example, in FIG. 2 the example doll (200) has a sensor or switch located on a shoe (201). (A shoe is an example of an article of clothing.) The pre-recorded English word repeated when the sensor or switch is activated could be “shoe”, optionally “red shoe” if the shoe is colored red. The word would be repeated in a foreign language and in English. Likewise, a pre-recorded phrase would contain the word “shoe”. An example of a phrase in English would be, “The color of my shoe is red.”

Also, the toy may have an accessory associated with it, such as a musical instrument (ie. a guitar) or a tool (ie. a hammer). For example, in FIG. 2 the example doll (200) is holding a guitar (202), with at least one sensor or switch located on it. (The guitar is an example of an accessory.) Thus, if the sensor or switch located on the guitar is activated, the pre-recorded English word could be “guitar” repeated in a foreign language and in English. Alternatively, if the sensor or switch is located on the strings of the guitar (203), the pre-recorded English word could be “string” or “strings”. Likewise, a pre-recorded phrase could contain the word “guitar”. An example of a phrase in English could be, “I play songs on my guitar”.

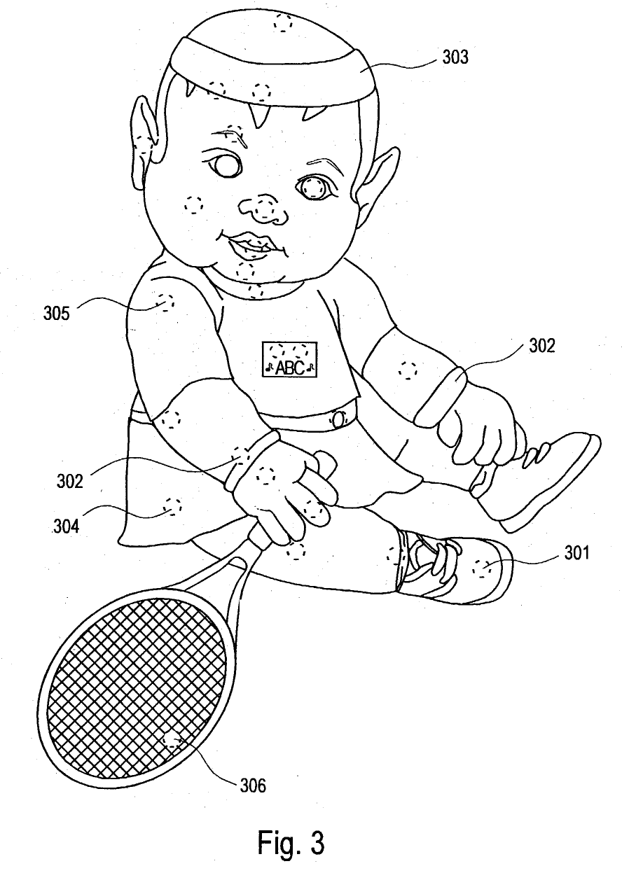

In another embodiment, the toy is dressed in clothes and accessories which compliment a learning theme toy (300). FIG. 3 shows an example of a doll dressed in a learning theme. A learning theme doll (300) is dressed in articles of clothing for a sport, activity or action, optionally including accessories (or tools), to play such sport or perform such activity or action.

For example, in FIG. 3 the toy is dressed like a tennis player, thus, the articles of clothing the doll (300) would wear should be complimentary to a tennis player. Accordingly, the toy of FIG. 3 is dressed in tennis shoes (301), wrist bands (302), head band (303), tennis skirt (304), shirt (305), and a tennis racket (306) in hand. Each accessory and article of clothing may have at least one sensor or switch placed on it, and said words or phrases enunciated by the doll would be associated with said article of clothing or accessory. For example, if a sensor or switch located on the tennis racket is activated, the doll may repeat, “I play tennis on a tennis court” in a foreign language and in English.

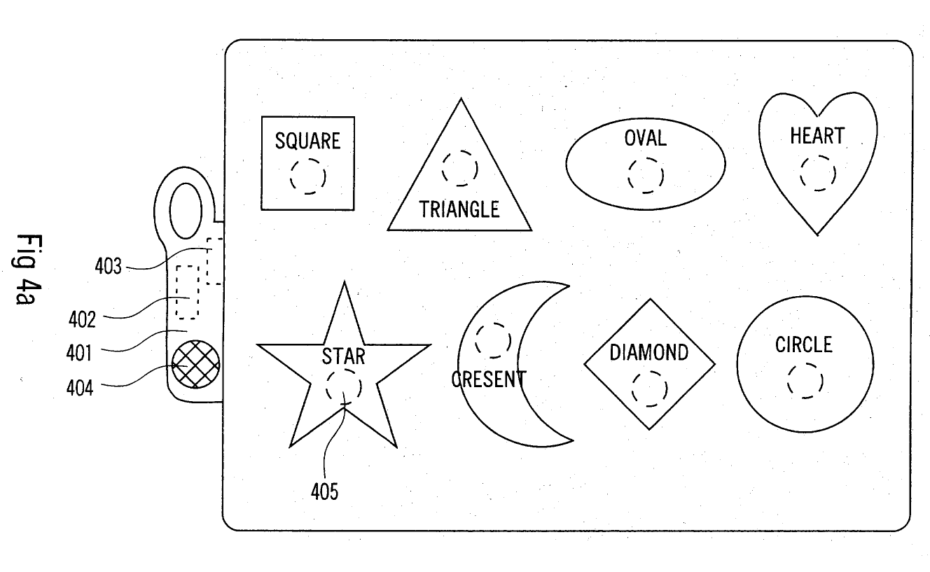

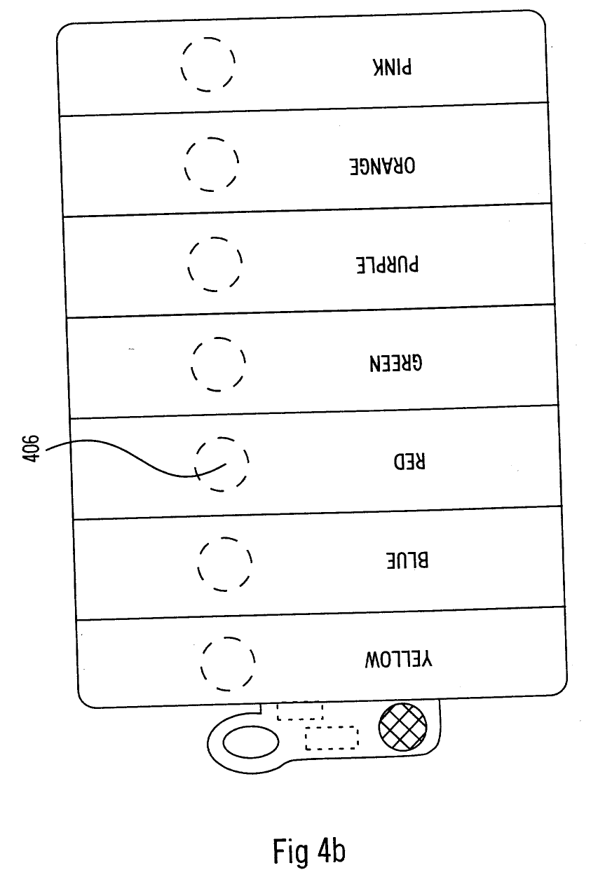

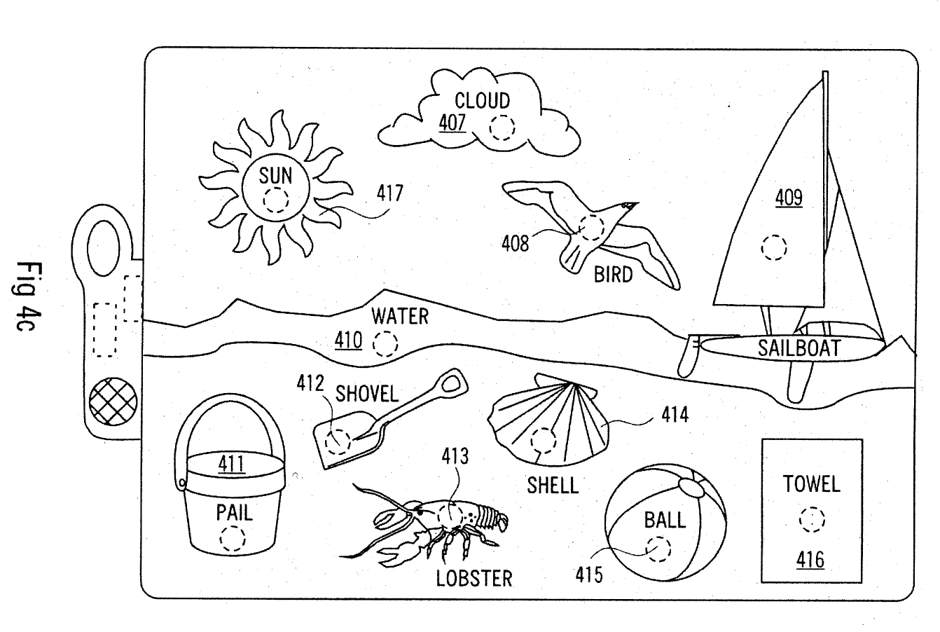

In another embodiment, the toy is an electronic mat (400). The terms “mat”, “pad” and “roll” can be used interchangeably. The mat comprises one or more sensors or switches located on the surface of the mat. As shown in FIG. 4a, the audio playback means (402), battery (403) and speaker (404), collectively the control unit (401), can be mounted in any suitable place. In one embodiment, the control unit is located at the end of the mat. Not shown in FIG. 4 is the electronic circuitry which connects the sensors or switches to the control unit. Accordingly, any type of electronic circuitry well known in the art and capable of communicating data signals may be used.

The mat can be manufactured and filled with any material known in the art.

The mat is structured so that activation of a sensor or switch on one area of the mat will immediately turn the power on the audio playback means (402) and play the word or phrase associated with the particular sensor or switch. The word or phrase would be said in two different languages, preferably in a foreign language and in English, more preferably twice in a foreign language and twice in English.

In another aspect, activating one sensor or switch by pressing onto the area around the sensor or switch will not activate any other nearby sensor or switch in that region. In another aspect, the speech phrase will play even if another speech phrase is currently playing, i.e., it will supersede the earlier speech phrase.

In another aspect, the pre-recorded word or phrase is related to the feature (i.e., the color, the shape, the picture, etc.) the sensor or switch is located on. For example, in FIG. 4a, a sensor or switch located on the star (405) would repeat words or phrases appropriate to the star in a foreign language and in English. In FIG. 4b, sensors or switches that activate the audio playback means to repeat words or phrases appropriate to the color blue (406) are situated directly on the mat part colored blue.

In yet another aspect of the invention, the mat is decorated in a learning theme. The learning theme mat as shown in FIG. 4c is decorated in a beach theme. Each picture depicted on the example mat relates to an ocean beach. Optionally the mat could include accessories (or tools) to interact with the learning theme depicted on the mat. Each picture depicted on the mat may have at least one sensor or switch placed on it, and said words or phrases enunciated by the audio playback means would be associated with said picture underlying the sensor or switch. For example, in FIG. 4c, if a sensor or switch located on the pail (411) is activated, the mat may repeat the word “pail” or the phrase, “I can put sand in my pail.” in a foreign language and in English.

In another embodiment, the toy is a house. The house has mounted on it at least one sensor or switch that activates an audio playback means, activated by a battery. Activation of a sensor or switch allows a pre-recorded word or phrase to be enunciated by the toy, said word or phrase will be related to the room of the house where the sensor or switch is located. In this embodiment, if a sensor or switch is located in the bathroom of the house, the activation of a sensor or switch in the bathroom would activate the audio playback means to repeat words or phrases associated with the bathroom or optionally objects located in the bathroom.

In another embodiment, the toy is shaped like a number or letter of the alphabet having one or more sensors or switches located thereon. Activation of the sensors or switches allows a pre-recorded word or phrase related to the letter or number to be accessed and played. For example, if the toy is shaped like the letter “A”, the English word enunciated by the audio playback means could be the letter “A”. The letter “A” would be repeated in a foreign language, if applicable, and in English. Likewise, a phase which includes the letter “A” would be repeated in a foreign language, if applicable, and in English. For example, “Apple starts with the letter ‘A’”.

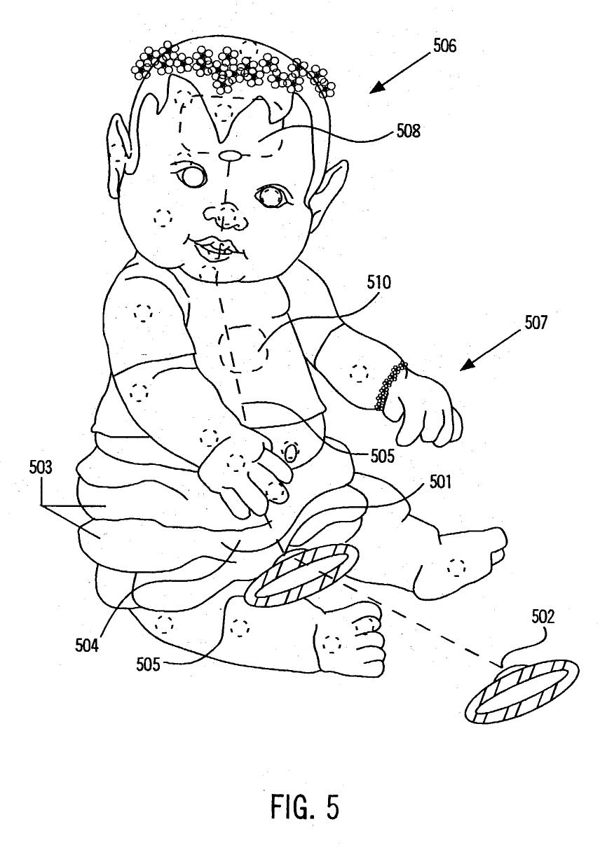

In another embodiment, the toy is a pull-string toy (500) as shown in FIG. 5, which after the pull string (505) re-coils from an extended second position (502) to a first position (501), a phrase in a foreign language and in English is enunciated from the audio playback means (508). Optionally, the pull string toy may have one or more sensors or switches located thereon.

The pull string toy (500) body is defined by at least two accordion pleats (503) forming a bellows region (504). The accordion pleats have a substantially symmetric shape and each pleat is substantially concentric around the pull string (505) when the pull string (505) is extended to the second position (502). Accordingly, the appearance of the pleats is not distorted at all positions of the pull string.

The pull string toy (500) as shown in FIG. 5 has a pull string (505) extending from the head (506) through the body (507) and is displaceable under tension between a first predetermined position (501) and a second predetermined position (502). When the string is extended to the second predetermined position (502), the battery means (510) is activated by the tension created in the pull string. Activation of the battery means (510) energizes the audio playback means (508) and pre-recorded words or phrases are enunciated by the doll when the string (505) is recoiled from the second position (502) to the first position (501). The words or phrases are heard by the user through a speaker (509). The speaker can be mounted in any suitable region of the pull string toy (500), thus, it is not shown in FIG. 5.

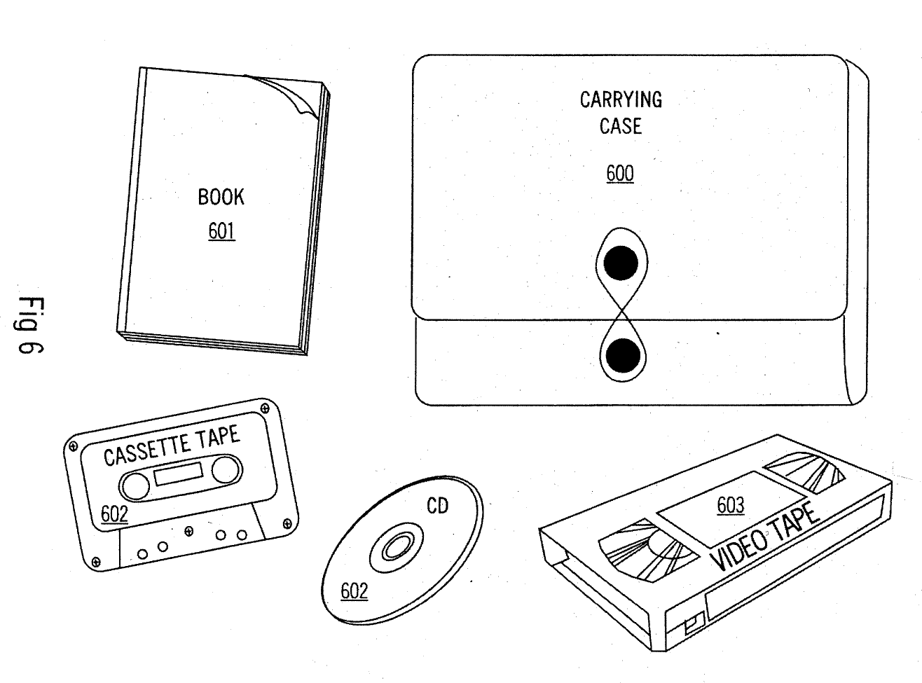

In another embodiment, a kit (600) comprising written materials (601), audio media (602) or visual media (603) may be provided with or sold separate from the respective toys. FIG. 6 shows several examples of the materials which could be included in the kit. The written material, which may take the form of a small booklet, flashcards, electronic pad/board, posters and the like, provides visual reinforcement. All printing is bilingual, written first in a foreign language then immediately followed in the English language. The written material would correspond to the words or phrases enunciated by the toy. By following each word by word, the child becomes familiar with the written counterpart of the phonetic sounds emitted from the doll thus increasing his or her bilingual knowledge. Visual media such as, but not limited to, videotapes, DVDs or any other visual cue may be used in conjunction with the doll. Such visual media could be a movie sold with the toy, wherein the toy is the main character. Words and phrases enunciated by the toy in two different languages would be depicted in said movie and show the end user watching the movie how the toy is played with. Audio media such as, but not limited to, audio tapes, CD's, mini-disks or any other media that are used in an appropriate piece of equipment to generate the audible sound may be used in conjunction with the doll. For example, sing along tapes could be included or sold separately with the toy.

Although the preceding description contains many embodiments and aspects, they should not be considered as limiting the spirit and scope, but as providing some of the aspects and embodiments of the present invention. Individual aspects and embodiments of the present invention may be combined with each other individual aspects and embodiments. Modifications of the individual aspects and embodiments is also considered, as the scope of this specification should be determined by the attached claims and their legal equivalents rather than by the examples given.

What is claimed is:

1. A bilingual toy comprising:
(a) at least one sensor or switch located on said toy;
(b) an audio playback means located within said toy with one or more words or phrases contained thereon in two different languages, wherein said audio playback means is activated by said sensor or switch;
(c) said word or phrase repeated by said audio playback means is related to a feature upon which said sensor or switch is located;
(d) a power source contained within said toy.

2. The toy according to claim 1 wherein said toy is a doll.

3. The toy according to claim 2 wherein said feature is an anatomical feature.

4. The toy according to claim 1 wherein said word or phrase is repeated in a foreign language and in English.

5. The toy according to claim 1 wherein said feature is a color.

6. The toy according to claim 1 wherein said feature is an article of clothing.

7. The toy according to claim 6 wherein said feature is a color of the article of clothing.

8. The toy according to claim 1 wherein said feature is an accessory.

9. The toy according to claim 1 wherein said toy is dressed in a learning theme.

10. The toy according to claim 1 wherein said words or phrases are randomly accessed.

11. The toy according to claim 1 wherein said toy is a mat.

12. The toy according to claim 1 1 wherein said feature is a shape, color or learning theme depicted on said mat.

13. The toy according to claim 1 wherein said toy is a pull string toy.

14. A bilingual pull string toy comprising:
(a) a body comprised of a head and torso;
(b) an audio playback means disposed in said body of said pull string toy;
(c) a pull string being extendably displaceable under tension between a first predetermined position and a second predetermined position;
(d) said audio playback means being activated when said pull string is extended to said second predetermined position;
(e) a word or phrase emitted in a foreign language and in English when said pull string recoils from said second position to said first position; and
(f) a power source contained in said pull string toy.

15. A kit for teaching a foreign language comprising:
(a) said toy of claim 1 or 14; and
(b) written materials, visual media or audio media.

16. An apparatus for teaching a foreign language comprising:
(a) said toy of claim 1 or 14; and
(b) written materials, visual media or audio media.
